(19) United States
(12) Patent Application Publication
(10) Pub. No.: US 2013/0177868 A1
(43) Pub. Date: Jul. 11, 2013

(54) DENTAL CLEANING APPLIANCE GENERATING HIGH VELOCITY WATER DROPLETS WITH REPLACEMENT TIP

(71) Applicants: Dan Defenbaugh, Eindhoven (NL); Dainia Edwards, Eindhoven (NL)

(72) Inventors: Dan Defenbaugh, Eindhoven (NL); Dainia Edwards, Eindhoven (NL)

(73) Assignee: KONINKLIJKE PHILIPS ELECTRONICS N.V., EINDHOVEN (NL)

(21) Appl. No.: 13/820,694

(22) PCT Filed: Sep. 19, 2011
(86) PCT No.: PCT/IB2011/054088

§ 371 Date: Mar. 4, 2013

Related U.S. Application Data
(60) Provisional application No. 61/388,039, filed on Sep. 30, 2010.

(51) Int. Cl. A61C 17/02

(52) U.S. Cl. CPC A61C 17/02
USPC 433/80

(57) ABSTRACT

The appliance includes an elongated body portion (12) and an assembly (14, 16 18) for producing high velocity water droplets, as well as a nozzle and guidance assembly (20) which includes a base portion (21) and a replaceable tip portion (22). The tip portion is connectable to the base portion by a connection arrangement, such as a weld, an adhesive, or a threaded connection.

This invention relates generally to dental appliances generating high velocity water droplets for cleaning, and more particularly concerns a nozzle assembly for such an appliance.

U.S. patent application Ser. No. 61/281,589 discloses a dental cleaning appliance having a body portion in which is positioned conventionally a liquid droplet generation system, a source of power and a control system with an on/off switch for the user. The appliance terminates in an integral nozzle and guidance assembly having a particular tip configuration which includes a central extending member through which high velocity water droplets exit, an intermediate trough portion and an edge ring portion which extends at its highest point above the outer boundary of the trough portion.

While in general, such an arrangement is suitable for many users, the configuration of the disclosed nozzle does not work well for every user. In addition, due to wear or other factors, the nozzle assembly should be replaced from time to time. Further, individual users may desire a tip with different physical characteristics, such as different degrees of hardness, during various seasons of use, or be able to select a particular tip or tips especially suitable for their own teeth geometry. The same is true for other aspects of the nozzle assembly, including the length of the central extending member and the size and configuration of the edge ring. It is thus desirable that such a cleaning apparatus having an adaptable nozzle which is useful for a large number of individual users.

Accordingly, the appliance for cleaning teeth with high velocity liquid droplets, comprises: a body portion; a system associated with the body portion for producing high velocity liquid droplets; and a nozzle and guidance assembly at one end of the body portion having an exit port member through which the liquid droplets leave the appliance, wherein the nozzle and guidance assembly includes a base portion and a replaceable tip portion which is matable with the base portion.

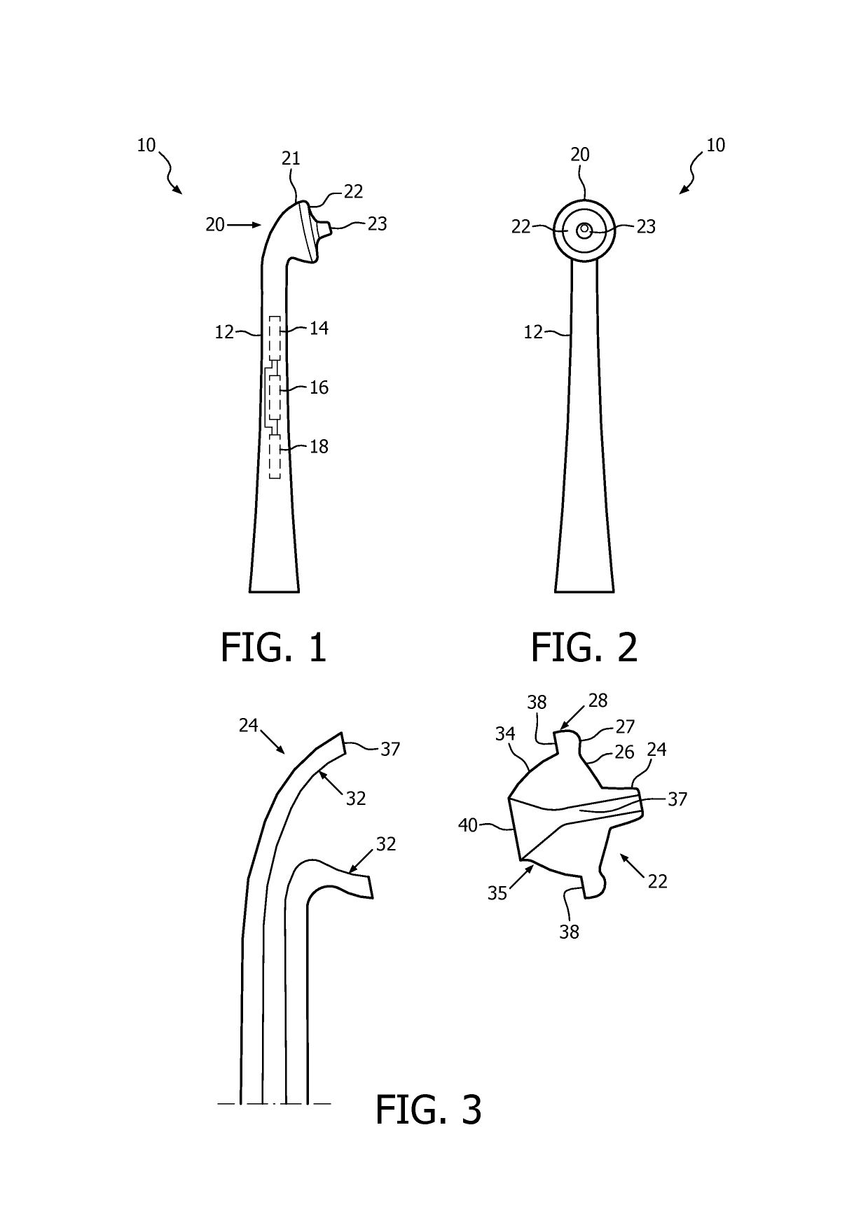

FIGS. 1 and 2 are side elevational and front views of an appliance with a nozzle assembly as described and shown herein.

FIG. 3 is an exploded view of the nozzle assembly of FIG. 1.

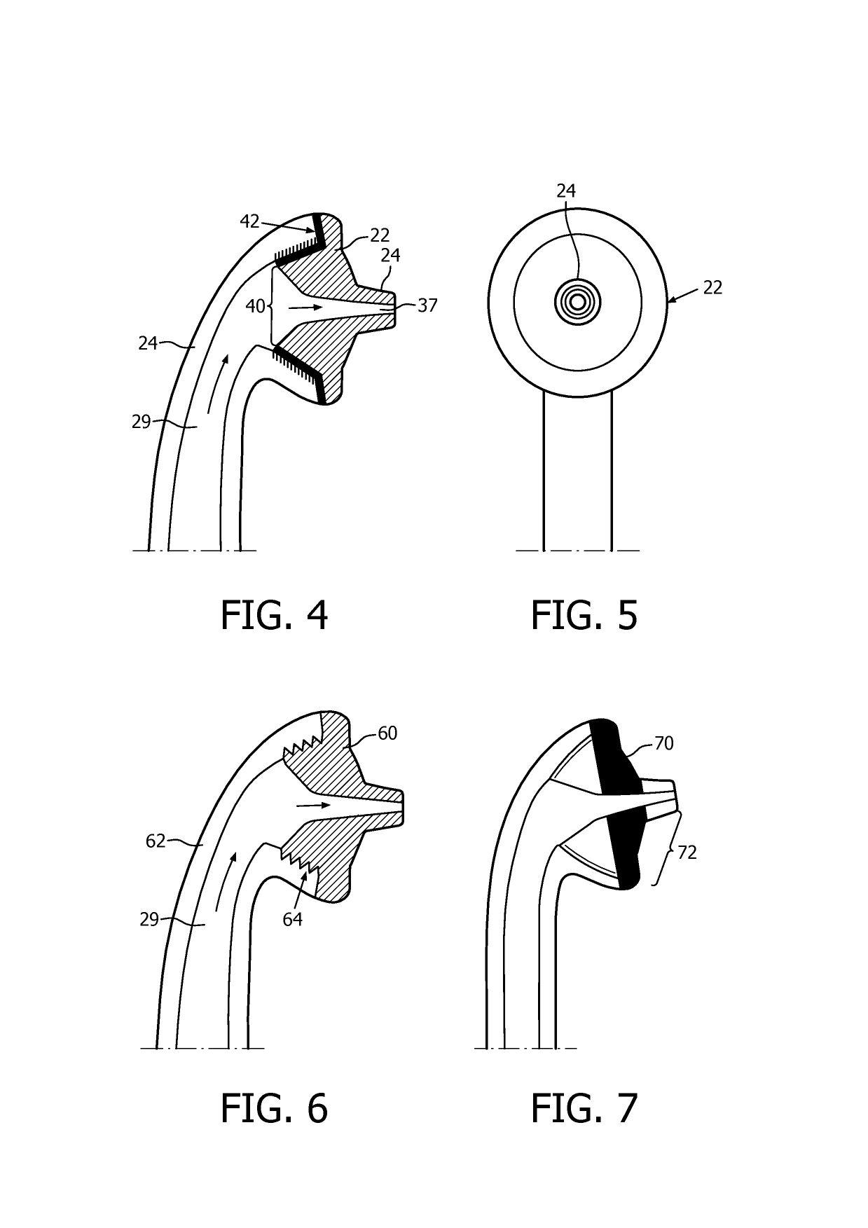

FIGS. 4 and 5 are cross-sectional and front elevational views of the nozzle assembly of FIG. 1 showing a representative connection between a replaceable nozzle tip and a base portion of the nozzle assembly.

FIG. 6 is a cross-sectional view showing another connection between the nozzle tip and the base of the nozzle assembly.

FIG. 7 is a cross-sectional view of the nozzle assembly with a portion which can be impregnated to produce different tastes and scents.

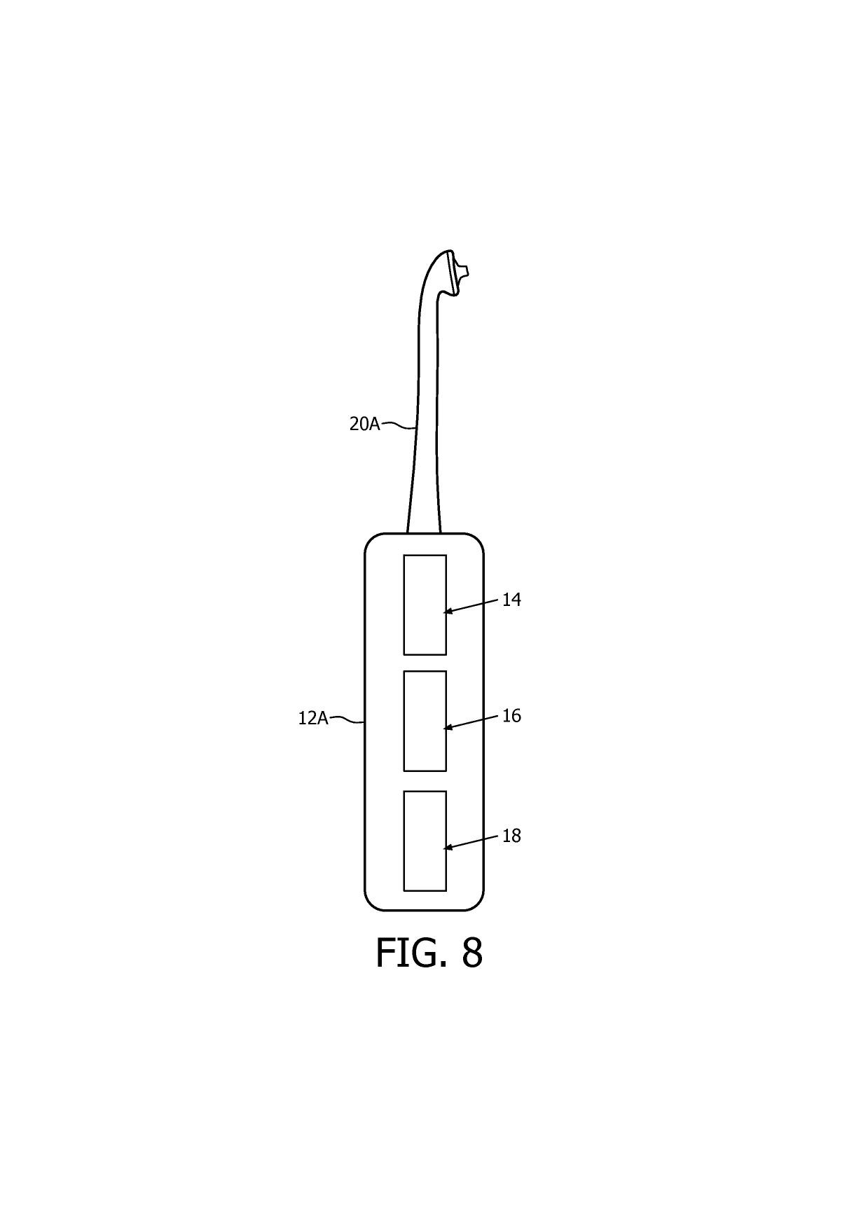

FIG. 8 is a side elevational view of a variation of the overall appliance configuration of FIG. 1.

FIGS. 1 and 2 show in general a cleaning apparatus for teeth at 10 which produces a stream of high velocity liquid droplets such as water to perform the cleaning function. Such an appliance is particularly useful in cleaning interproximal areas of the teeth. The appliance 10 generally includes an elongated body portion 12 which includes a liquid droplet generating system 14, a power assembly for the appliance 16 and a control assembly 18 for control of the water droplet system. A variation of this arrangement is shown in FIG. 8, with 20A referring to the nozzle assembly and 12A referring to a separate handle portion, in which are positioned a liquid droplet generating system 14, a power assembly 16 and a control assembly 18, as well as any other elements needed for operation of the appliance. These portions are not explained in detail, since they may take various conventional forms and arrangements. In FIGS. 1 and 2 the elongated body portion 12 terminates in a nozzle and guidance assembly 20 which includes a base portion 21 and a tip portion 22. At the center of tip portion 22 is an exit opening 23 through which high velocity droplets are delivered to the teeth of the user for cleaning when the appliance is positioned properly by the user in the mouth.

In the general configuration of the nozzle and guidance assembly, referring to FIG. 3, a central elevated exit member 24 extends above a surrounding intermediate trough portion 26 by approximately 1-3 mm. In some cases, the exit member can be slightly tapered, with an exterior diameter of approximately 2 mm. The intermediate trough portion 26 is approximately 8-16 mm in diameter and tapers slightly away from the exit member 24. The intermediate trough portion 26 terminates in a boundary portion 28 which has a curved upper surface 27 which defines a lip for the tip portion 22. Additional details and advantages of such a structure are set forth in the above-noted U.S. application Ser. No. 61/289,589, which is owned by the assignee of the present invention, the contents of which application are hereby incorporated by reference.

In the present arrangement, tip portion 22 of the nozzle assembly 20 is separable from a base portion 24 thereof which extends from body 12. This is shown for instance in FIG. 3, where tip portion 22 is set apart from the base portion 24. The tip portion hence is replaceable. The view of FIG. 3 is shown before tip portion 22 is joined to base portion 24. The interior surface 32 of the base portion, and the exterior surface 34 of the tip portion must each have connecting features, and are generally configured to mate with each other. In the arrangement of FIG. 3, the tip portion includes a lower circumferential surface 35 and a circumferential engaging surface 38. The lower circumferential surface 35 mates with surface 32 of the base portion, while the circumferential engaging surface 38 mates with forward edge surface 37 of the base portion.

As can be seen from FIG. 3, tip portion 22 includes an internal channel 37 which at its entry area 40 mates connects the internal surface 32 of the base portion, as illustrated in FIG. 4, and is hence quite wide, typically 5 mm in diameter, however, this can vary depending upon the particular appliance configuration. Channel 37 in the embodiment shown will taper inwardly, such as shown in FIG. 3 or 4, decreasing in diameter toward the exit of the tip portion until it reaches an exit diameter of approximately 1 mm. This can be done with various channel configurations, including the more angular surface arrangement shown in FIG. 4.

Various possible connection arrangements between the tip portion and the base of the nozzle are represented by connecting element 42 in FIG. 4. In FIG. 4, the connecting element can be a weld or an adhesive, or there could be a pressure fit between the tip and base portions. The flow path of the liquid droplets is represented at 29. FIG. 5 shows another arrangement, in which the tip portion 60 and base portion 62 are connected by a threaded arrangement, referred to generally at 64. Other connection arrangements are possible as well. The ones shown in FIG. 4-6 and discussed herein are examples only.

The replaceable tip portion of the nozzle has a number of advantages. These include the ability to replace the tip of the nozzle due to wear. It also permits nozzle variations depending on a desired hardness, (or softness) of the material. Further, the diameter of the exit orifice of the tip portion can be changed to alter the characteristic of the liquid droplet spray.

Still further, the height of elevated exit member 24 of the tip portion can be changed relative to the intermediate trough portion. This capability permits use of the appliance with various orthodontic appliances as well adjusting to the individual geometry of user's teeth. Still further, the configuration and arrangement of the boundary portion 28 can be changed to make it larger or smaller, or even in some cases to eliminate the raised part, again to accommodate different teeth geometry. The replaceable tip portion which provides both a nozzle function and a guidance function to insure proper placement on the teeth makes the appliance truly adaptable for almost all teeth geometry, so that there is no compromise in performance to accommodate a range of teeth geometries.

A portion, such as region 70 in FIG. 7, or all, of a tip portion 72 can be impregnated with material producing different taste or smell characteristics. Examples are coffee, mint and cinnamon; other flavors can be used as well. The taste or smell of the nozzle tip can be changed to suit the desire or whim of the user. The material could also be one which transfers to the surface of the teeth to indicate proper placement of the nozzle.

Still further, the tip portion may have a replacement indication capability, involving for instance, a change of color of the tip portion over time, or a reduction in the smell of the tip portion.

The impregnated material can also be used for treatment, including halitosis (bad breath), or teeth whitening or to treat bacteria, among other conditions.

Accordingly, a new nozzle arrangement for a liquid droplet appliance has been disclosed involving a nozzle base and a nozzle tip which is removably secured to the nozzle base. This permits exchange of nozzle tips to produce different nozzle actions and functions. Various arrangements can be used to connect the tip portion to the base portion.

Although a preferred embodiment has been disclosed for purposes of illustration, it should be understood that various changes and modifications and substitutions could be made in the preferred embodiment without departing from the spirit of the invention as defined by the claims which follow:

1. An appliance for cleaning teeth with high velocity liquid droplets, comprising:
a body portion;
a system associated with the body portion for producing high velocity liquid droplets; and
a nozzle and guidance assembly at one end of the body portion having an exit port member through which the liquid droplets leave the appliance, wherein the nozzle and guidance assembly includes a base portion with a forward end and a replaceable tip portion positioned at the forward end of the base portion which has a rear part which fits into the forward part of the base portion and which is matable with the base portion and further which is configured for placement on the teeth for cleaning thereof wherein the replaceable tip portion has a channel therethrough to the exit port member, wherein the channel narrows from the rear part of the tip portion to the exit port member.

2. The appliance of claim 1, wherein the replaceable tip portion comprises material of selected hardness.

3. The appliance of claim 1, wherein the exit port member has a selectable geometry to accommodate different teeth geometries.

4. The appliance of claim 1, wherein the replaceable tip portion has a selectable boundary portion geometry to accommodate different teeth geometries.

5. The appliance of claim 1, wherein at least a part of the tip portion is impregnated with a material producing a selected odor or taste.

6. The appliance of claim 1, wherein at least a part of the tip portion is impregnated with a material which is suitable for treatment for treatment of a mouth condition or for teeth whitening.

7. The appliance of claim 6, wherein the mouth condition is halitosis or the presence of bacteria.

8. The appliance of claim 1, wherein the tip portion is matable to the base portion by a threaded connection.

9. The appliance of claim 1, wherein the tip portion is matable to the base portion by an adhesive or a weld.

10. In an appliance for cleaning teeth using high velocity water droplets, wherein the appliance includes a body portion and an assembly for producing high velocity water droplets, a nozzle assembly comprising:
a base portion with a forward end thereof, and
a replaceable tip portion positioned at the forward end of the base portion, wherein the tip portion includes a rear part which fits into the forward end of the base portion and which is matable to the base portion and which is configured for placement on the teeth for cleaning thereof, wherein the tip portion includes a channel therethrough to an exit from the tip portion wherein the channel narrows from the rear end of the tip portion to the exit from the tip portion.

11. The nozzle assembly of claim 10, wherein the replaceable tip portion comprises material of selected hardness.

12. The nozzle assembly of claim 10, wherein at least part of the replaceable tip portion is impregnated with a material producing a selected odor or taste.

13. The nozzle assembly of claim 10, wherein the tip portion has an exit part member which has a selectable geometry to accommodate different teeth geometries.
